(19) United States
(12) Patent Application Publication
(10) Pub. No.: US 2021/0214651 A1
(43) Pub. Date: Jul. 15, 2021

(54) Clear Fabric Care Composition

(71) Applicant: Colgate-Palmolive Company, New York, NY (US)

(72) Inventors: Oscar BAUTISTA CID, Mexico D.F. (MX); Erick CARDENAS ALPIZAR, Mexico D.F. (MX); Susana REYNA ZAMORA, Mexico DF (MX)

(73) Assignee: Colgate-Palmolive Company, New York, NY (US)

(21) Appl. No.: 16/771,925

(22) PCT Filed: Dec. 14, 2017
(86) PCT No.: PCT/US2017/066252

§ 371 Date: Jun. 11, 2020

(51) Int. Cl. C11D 3/00; C11D 11/00; C11D 3/43; C11D 3/50; C11D 3/37; C11D 17/00

(52) U.S. Cl. CPC C11D 3/0015; C11D 11/0017; C11D 3/43; C11D 17/0021; C11D 3/3776; C11D 3/3707; C11D 3/3765; C11D 3/505

(57) ABSTRACT

A fabric car composition, including a fabric softening agent that includes polyquaternium-7, a thickener that includes at least one of a polyoxyethylene sorbitol tetra stearate thickener and an acrylate copolymer; and a co-solvent that includes alcohol ethoxylates.

### BACKGROUND

Fabric care compositions are generally used during the rinse or drying cycle of a laundry process to improve various characteristics of laundered fabric articles, such as softness, fragrance, static reduction, and ease of ironing. Typically, liquid fabric care compositions are used in the rinse cycle and solid fabric care compositions are used in the drying cycle, usually incorporated onto woven substrates placed in the laundry dryer.

Esterquats, a quaternary ammonium compound, are a common active ingredient of liquid fabric care compositions used to achieve the desired softness, fragrance, static reduction, and/or ease of ironing characteristics. Esterquats are typically formed when the reaction product of long chain fatty acids and a tertiary amine is esterified in the presence of an acid catalyst and subsequently quaternized to obtain quaternary ammonium salts. Esterquats are commonly a mixture of mono-, di- and triester components.

However, esterquats can also be one of the main cost components of a fabric care composition due to the cost of the raw materials required for their production and their complicated chemistry. In addition, their chemical properties also make it hard to replace, adjust, or add other ingredients to the fabric care composition without affecting its performance.

Accordingly, it would be useful to develop fabric care compositions that replace esterquat with new more cost effective ingredients. In addition, it would be useful to develop clear or translucent fabric care compositions that, nonetheless, provide comparable performance to known esterquat-containing fabric care compositions.

### BRIEF SUMMARY

This summary is intended merely to introduce a simplified summary of some aspects of one or more embodiments of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The foregoing and/or other aspects and utilities embodied in the present disclosure may be achieved by providing a fabric care composition, including a fabric softening agent in an amount from 0.01 weight % to 2.5 weight %, based on a total weight of the fabric care composition, wherein the fabric softening agent includes polyquaternium-7; a thickener in an amount from 0.5 weight % to 4.0 weight %, based on the total weight of the fabric care composition, wherein the thickener includes at least one of a polyoxyethylene sorbitol tetra stearate thickener and an acrylate copolymer; and a co-solvent in an amount from 0.1 weight % to 5.0 weight %, based on the total weight of the fabric care composition, wherein the co-solvent includes alcohol ethoxylates.

In another embodiment, the fabric care composition is clear or translucent.

In another embodiment, the fabric care compositions has a turbidity value of 50 NTU or less.

In another embodiment, the fabric care compositions has a turbidity value of 30 NTU or less.

In another embodiment, the fabric care composition includes no surfactants other that the co-solvent and wherein the fabric softening agent consists of polyquaternium-7.

In another embodiment, the fabric care composition has a viscosity from 30 to 500 cP.

In another embodiment, the fabric softening composition further includes an aqueous carrier; and a fragrance in an amount from 0.01 weight % to 0.5 weight %, based on a total weight of the fabric care composition.

In another embodiment, the fabric softening composition includes from 0.01 weight % to 0.40 weight % polyquaternium-7; an aqueous carrier; and from 1.0 weight % to 4.0 weight % co-solvent.

In another embodiment, the fragrance is an encapsulated fragrance.

In another embodiment, the thickener includes a polyoxyethylene sorbitol tetra stearate.

In another embodiment, the thickener includes an acrylate copolymer.

In another embodiment, the co-solvent is an alcohol C9-C11 ethoxylate (EO 7.5:81).

The foregoing and/or other aspects and utilities embodied in the present disclosure may also be achieved by providing a fabric care composition, including from 0.01 weight % to 0.40 weight % polyquaternium-7, based on a total weight of the fabric care composition; an aqueous carrier; from 0.5 weight % to 4.0 weight % thickener, based on the total weight of the fabric care composition; from 0.1 weight % to 5.0 weight % co-solvent, based on the total weight of the fabric care composition; and from 0.01 weight % to ×0.5% fragrance, based on the total weight of the fabric care composition, wherein the fabric care composition includes no other fabric softening agents or surfactants.

In another embodiment, the fabric care composition has a clear or translucent appearance.

In another embodiment, the fabric care composition has a turbidity value of 50 NTU or less.

In another embodiment, the fabric care composition has a viscosity from 30 to 500 cP.

In another embodiment, the components of the fabric care composition have a particle size of 50 nanometers or less.

In another embodiment, the fragrance is an encapsulated fragrance and is provided as a micro-emulsion of the encapsulated fragrance and at least one of the thickener and the co-solvent.

In another embodiment, the thickener includes an acrylate copolymer or a polyoxyethylene sorbitol tetra stearate.

In another embodiment, the co-solvent is an alcohol C9-C11 ethoxylate (EO 7.5:81).

### DETAILED DESCRIPTION

Reference will now be made in detail to the various embodiments in the present disclosure. The embodiments are described below to provide a more complete understanding of the components, processes, compositions, and apparatuses disclosed herein. Any examples given are intended to be illustrative, and not restrictive. However, it will be apparent to one of ordinary skill in the art that the invention may be practiced without these specific details. In other instances, well-known methods, procedures, and components have not been described in detail so as not to unnecessarily obscure aspects of the embodiments.

Throughout the specification and claims, the following terms take the meanings explicitly associated herein, unless the context clearly dictates otherwise. The phrases “in some embodiments” and “in an embodiment” as used herein do not necessarily refer to the same embodiment(s), though they may. Furthermore, the phrases “in another embodiment” and “in some other embodiments” as used herein do not necessarily refer to a different embodiment, although they may. As described below, various embodiments may be readily combined, without departing from the scope or spirit of the present disclosure.

As used herein, the term “or” is an inclusive operator, and is equivalent to the term “and/or,” unless the context clearly dictates otherwise. The term “based on” is not exclusive and allows for being based on additional factors not described, unless the context clearly dictates otherwise. In the specification, the recitation of “at least one of A, B, and C,” includes embodiments containing A, B, or C, multiple examples of A, B, or C, or combinations of A/B, A/C, B/C, A/B/B/B/B/C, A/B/C, etc. In addition, throughout the specification, the meaning of “a,” “an,” and “the” include plural references. The meaning of “in” includes “in” and “on.”

It will also be understood that, although the terms first, second, etc. may be used herein to describe various elements, these elements should not be limited by these terms. These terms are only used to distinguish one element from another. For example, a first object, component, or step could be termed a second object, component, or step, and, similarly, a second object, component, or step could be termed a first object, component, or step, without departing from the scope of the invention. The first object, component, or step, and the second object, component, or step, are both, objects, component, or steps, respectively, but they are not to be considered the same object, component, or step. It will be further understood that the terms “includes,” “including,” “comprises” and/or “comprising,” when used in this specification, specify the presence of stated features, steps, operations, elements, and/or components, but do not preclude the presence or addition of one or more other features, steps, operations, elements, components, and/or groups thereof. Further, as used herein, the term “if” may be construed to mean “when” or “upon” or “in response to determining” or “in response to detecting,” depending on the context.

All physical properties that are defined hereinafter are measured at 20° to 25° Celsius unless otherwise specified.

When referring to any numerical range of values herein, such ranges are understood to include each and every number and/or fraction between the stated range minimum and maximum, as well as the endpoints. For example, a range of 0.5-6% would expressly include all intermediate values of, for example, 0.6%, 0.7%, and 0.9%, all the way up to and including 5.95%, 5.97%, and 5.99%, among many others. The same applies to each other numerical property and/or elemental range set forth herein, unless the context clearly dictates otherwise.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith.

Unless otherwise specified, all percentages and amounts expressed herein and elsewhere in the specification should be understood to refer to percentages by weight. The amounts given are based on the active weight of the material. Unless otherwise specified, all component or composition amounts are in reference to the active amount of that component or composition, and exclude impurities or by-products, which may be present in commercially available sources.

With regard to procedures, methods, techniques, and workflows that are in accordance with some embodiments, some operations in the procedures, methods, techniques, and workflows disclosed herein may be combined and/or the order of some operations may be changed.

A fabric care composition as disclosed herein includes a fabric softening agent and a co-solvent. The fabric care compositions may be in liquid form and may include an aqueous carrier (i.e. may be an aqueous fabric care composition). In some embodiments, the fabric care composition is easily dispersible in water.

In some embodiments, the fabric care composition is clear or translucent. As used herein, the term “clear” is defined as transparent, preferably as in “water clear,” when observed through a layer having a thickness of less than about 10 cm. As used herein “translucent” is defined as allowing light to pass through but not clearly or semi-transparent. In other embodiments, clarity or translucence is determined via turbidity measurements. For example, fabric care compositions with a clarity value below about 70 nephelometric turbidity units (NTU), preferably below 60 NTU, may be considered “clear,” while fabric care composition with a clarity value below 50 NTU, preferably below 50 NTU are considered “translucent.” Turbidity may be measured using a HACH 2100Q portable Turbidimeter. In one embodiment, the fabric care composition has a turbidity value of 70 NTU or less. In other embodiments, the fabric care composition has a turbidity value of 60 NTU or less, 50 NTU or less, 40 NTU or less, or 30 NTU or less. In one embodiment, the fabric care composition has a turbidity value between 30 and 50 NTU.

The fabric care composition includes a fabric softening agent. The fabric softening agent may be a polyquaternium polymer. According to one embodiment, the fabric softening agent is a stable, water-soluble, and liquid polyquaternium polymer. For example, the fabric softening agent may be polyquaternium-7. Polyquaternium-7 (PQ7) is the copolymer of acrylamide and diallyldimethylammonium chloride, and is usually represented with the following chemical formula: (C₈H₁₆ClN)ₙ(C₃H₅NO)ₘ. Polyquaternium-7 is available commercially as NOVERITE 300 from Lubrizol Corporation, Wickliffe, Ohio, or as Flocare LS737 from SNF Floerger, Andrézieux, France.

The inventors have surprisingly and unexpectedly discovered that, unlike other polyquaternium polymers, PQ7 produces a clear fabric care composition with excellent stability over time with superior performance when it is compared with current clear technologies, such as low chain oils or esterquats with low fatty-acid chains. Additionally, unlike other polyquaternium polymers, PQ7 provides additional advantages as it is provided in a liquid dispersion which makes it easier to process, especially in continuous manufacturing systems. PQ7 also form stable mixtures compared with powder or solid polyquaterniums. The superior performance of PQ7 is especially unexpected in view of the low amounts used, where such performance cannot be equaled by other polyquaternium polymers, such as Polyquaternium 67, Polyquaternium 5. PQ7 also showed improved fragrance delivery in some important key touch points for consumers.

In some embodiments, the fabric care composition includes up to 2.5 weight % fabric softening agent (e.g., polyquaternium-7), based on the total weight of the fabric care composition For example, the fabric care composition may include from 0.01 weight % to 0.40 weight % PQ7, based on the total weight of the fabric care composition. In certain embodiments, the fabric care composition includes from 0.05 weight % to 0.30 weight %, 0.10 weight % to 0.30 weight %, or 0.15 weight % c to 0.25 weight % fabric softening agent. For example, the fabric care composition may include from 0.05 weight % to 0.30 weight % polyquaternium-7 or from 0.15 weight % to 0.25 weight % polyquaternium-7.

In another embodiment, the amount of fabric softening agent in the fabric care composition may be determined by the amount of esterquat in a known esterquat-containing fabric care composition. That is, the inventors have surprisingly discovered a method of replacing esterquat in a known fabric care composition with established performance characteristics (e.g., softness, fragrance delivery, ease of ironing, wrinkly reducing, dispersion, etc.) with a fabric softening agent (e.g., polyquaternium-7), while maintaining similar or superior performance characteristics. In certain embodiments, the fabric care composition does not include any esterquat. By way of example, the amount of fabric softening agent in the fabric care composition may be determined by the following formula.

Y=−0.0043X2+0.0649X−0.0037 Formula 1

wherein X=desired amount of esterquat to be replaced, and
wherein Y=amount of PQ7 to provide similar performance as X amount esterquat

Formula 1 can be used to formulate a fabric care composition by replacing the amount of esterquat in a known esterquat-containing composition with polyquaternium-7 while maintaining a comparable performance. For example, under Formula 1, 1 weight % of esterquat may be replaced with 0.056% of polyquaternium-7. In another embodiment, 2 weight % of esterquat may be replaced with 0.108% weight % polyquaternium-7, or 3 weight % of esterquat may be replaced with 0.152% weight % polyquaternium-7.

The fabric care composition may be substantially free of fabric softeners other than the fabric softening agent. For example, in some embodiments, other than polyquaternium-7, the fabric care composition is substantially free of any other fabric softening agents.

In some embodiments, the fabric care composition is substantially free of surfactants. In some embodiments, other than the co-solvent, the fabric care composition is substantially free of surfactants. In other embodiments, the fabric care composition is substantially free of detersive surfactants. As used herein, the term “detersive surfactant” means surfactants with cleansing power. In another embodiment, the fabric care composition is substantially free of anionic surfactants. In some embodiments, other than the co-solvent, the fabric care composition is substantially free of surfactants.

The fabric care composition may include an aqueous carrier. For example, the fabric care composition may include water as the carrier. In certain embodiments, the amount of water is at least 30%, 40%, 50%, 60%, 70%, 80%, or 85% by weight of the composition. In certain embodiments, the fabric care composition includes 25 weight % or more water, based on the total weight of the fabric care composition. In certain embodiments, the fabric care composition includes 50 weight % or more water or 75 weight % or more water, based on the total weight of the fabric care composition.

In some embodiments, the fabric care composition may be a low-water or “concentrated” formulation intended to be diluted before use. In such embodiments, the fabric care composition includes lower amounts of the aqueous carrier. In certain embodiments, the amount of water is no more than 50%, 40%, 30%, 20%, 15%, or 10% by weight of the composition. For example, the fabric care composition may include 50 weight % or less water or 30 weight % or less water, based on the total weight of the fabric care composition.

In other embodiments, the fabric care composition may include water-soluble or water-dispersible solvents as carriers. For example, the fabric care composition may include water soluble solvents such as C4 to C10 glycol ethers, C2 to C7 glycols, polyethers, and glycerin.

The fabric care composition may also include other components commonly used in fabric care compositions in minor amounts to enhance either the appearance or performance of the fabric care compositions while maintaining a clear or translucent appearance. For example, the fabric care composition may include thickeners, fragrances, preservatives, dyes or pigments, bluing agents, germicides, and opacifying agents.

In some embodiments, the fabric care composition must be easily pourable by an end user. Accordingly, the viscosity of the fabric care composition should not exceed 500 centipois (cP) for ready-to-use fabric care compositions, preferably not more than 250 cP, and 10,000 cP for fabric care composition intended for dilution before use. In certain embodiments, the fabric care composition has a pour viscosity from 30 to 500 cP, or from 50 to 200 cP. Unless otherwise specified, viscosity is measured at 25° C. using a Brookfield RVTD Digital Viscometer with Spindle #2 at 50 rpm.

In order to adjust the viscosity, the fabric care composition may include one or more thickeners. However, the one or more thickeners may also need to support the clear or translucent nature of the fabric care composition.

The one or more thickeners may include associative thickeners that are water soluble and with a high molecular weight, including, for example, a molecular weight of between 200 g/mol and 10,000 g/mol. For example, the thickener can be a polyoxyethylene sorbitol tetra stearate thickener, commercially available as ALKONT EL 3645 from Oxiteno, S.A., São Paulo, Brazil. In other embodiments, the thickener may be an acrylate copolymer designed for high clarity, such as a polyacrylate-1 crosspolymer, commercially available as CARBOPOL AQUA CC POLYMER from Lubrizol Corporation, Wickliffe, Ohio. Other suitable thickeners include Polysorbate triesters, PEG-9 Cocoate, PEG-32 Distearate, and PEG-175 Distearate. In some embodiments, the thickeners have a hydrophilic-lipophilic balance (HLB) value of 10 or greater.

In certain embodiments, the fabric care composition includes no more than 5 weight % thickener, based on the total weight of the fabric care composition. In certain embodiments, the fabric care composition includes between 4 weight % and 0.5 weight % thickener, based on the total weight of the fabric care composition. In certain embodiments, the fabric care composition includes between 3 weight % and 0.5% weight %, between 2 weight % and 0.5 weight %, or between 2 weight % and 1 weight % thickener.

The fabric care composition may also include one or more co-solvents. The one or more co-solvents may include alcohol ethoxylates. For example, the one or more co-solvents may include alcohol C9-C11 ethoxylates (EO 7.5:81). Examples of suitable commercially available C9-C11 ethoxylates include NEODOL 91-8 and DOBANOL 91-52 (Shell Oil Co., Houston Tex.), ECOSURF EH-9 (Dow Chemical Co., Midland Mich.), and SYNPERONIC 91/8 (Croda Inc., Newark, N.J.).

In some embodiments, the co-solvent is used to prepare a micro-emulsion with at least one of the thickener and the fragrance. In some embodiments, the co-solvent is non-ionic. In other embodiments, the co-solvents may be a combination of an ionic surfactant and a nonionic surfactant, such as polyethylene glycol and ether.

In certain embodiments, the fabric care composition includes from 0.1 weight % to 5 weight % co-solvent, based on the total weight of the fabric care composition. In certain embodiments, the fabric care composition includes 4 weight % or less, 3 weight % or less, 2 weight % or less, 1 weight % or less, or 0.5 weight % or less co-solvent, based on the total weight of the fabric care composition. In certain embodiments, the fabric care composition includes between 4 weight % and 1 weight % co-solvent, based on the total weight of the fabric care composition. In certain embodiments, the fabric care composition includes between 3 weight % and 2 weight % co-solvent, based on the total weight of the fabric care composition.

The fabric care composition may include one or more fragrances or perfumes. As used herein, the term “fragrance” is used in its ordinary sense to refer to and include any non-water soluble fragrant substance or mixture of substances including natural (i.e., obtained by extraction of flower, herb, blossom or plant), artificial (i.e., mixture of natural oils or oil constituents) and synthetically produced odoriferous substances. The fabric care composition may include free fragrances, encapsulated fragrances, or a mixture of both.

In some embodiments, the fragrance provided as a micro-emulsion of the fragrance, the co-solvent, and/or the thickener. In certain embodiments, the micro-emulsion has a 3:1 ratio of fragrance to co-solvent. In certain embodiments, the micro-emulsion has a 4:1 ratio of fragrance to co-solvent.

Generally, encapsulated fragrances are not used in clear or translucent composition. However, the inventors have surprisingly discovered that a small amount of encapsulated fragrance can be added to the fabric care composition as a micro-emulsion and maintain a clear or translucent appearance. For example, in certain embodiments, the fabric care composition may include no more than 2.0%, 1.0%, 0.5%, 0.4%, 0.3%, 0.2%, 0.1%, or 0.05% encapsulated fragrance based on the weight of the fabric care composition. In a preferred embodiment, the fabric care composition includes from 0.01 weight % to 0.1 weight %, preferably 0.05 weight % to 0.07 weight %, encapsulated fragrance. In some embodiments, the encapsulated fragrance is emulsified with the thickener to avoid precipitation of the encapsulated fragrance. In some embodiments, the encapsulated fragrance comprises melamine capsules.

The fabric care composition may also include free fragrance or fragrance oils. The free fragrance may be emulsified with at least one of the thickener and the co-solvent. For example, the fabric care composition may include no more than 2.0%, 1.0%, 0.5%, 0.4%, 0.3%, 0.2%, 0.1%, or 0.05% free fragrance by weight of the composition. In certain embodiments, the fabric care composition includes between 0.01 weight % to 0.5 weight % free fragrance, based on the total weight of the fabric care composition. In certain embodiments, the fabric care composition includes 0.30 weight % or less free fragrance or 0.10 weight % c or less free fragrance, based on the total weight of the fabric care composition.

In order to maintain a clear or translucent appearance, the components of the fabric care composition may have a particle size between about 10 and about 100 nanometers. In other embodiments, the components of the fabric care composition has a particle size between about 10 and about 50 nanometers. The components of the fabric care composition may also have a particle size of 50 nanometers or less, 25 nanometers or less, or 10 nanometers or less. For example the fragrance micro-emulsions may have a particle size between about 10 and about 100 nanometers or a particle size of 50 nanometers or less. In some embodiments, the particle size requirements may be limited only to the fragrance components.

The fabric care composition may include one or more preservatives. The one or more preservatives may include one or more organic acids, such as lactic acid and/or phosphonic acid. For example, the fabric care composition may include combinations of food grade lactic acid and amino trimethyl phosphonic acid. In other embodiments, the fabric care composition may also include isothiazolinones as preservatives. For example, the one or more preservatives may include a (OIT/MIT/CIT) isothiazolinone mixture.

In certain embodiments, the fabric care composition includes 0.2 weight % or less preservative, based on the total weight of the fabric care composition. In certain embodiments, the fabric care composition includes 0.15 weight % or less preservative or 0.10 weight % or less preservative, based on the total weight of the fabric care composition.

The fabric care composition may be acidic. For example, the fabric care composition may have a pH range from 2.8 to 5, preferably from 2.8 to 3.8.

### EXAMPLES

Table 1 illustrates a performance comparison of a non-clear esterquat-containing fabric softening composition (3% esterquat—Comp. Ex. 1) against an exemplary clear fabric care composition according to the present disclosure (Example I).

In particular, the performance of the fabric care compositions was tested as follows: circular denim swatches were laundered using a commercially available laundry detergent (ARIEL PROFESSIONAL POWER, Procter & Gamble) in a washing machine at the following conditions: washing water volume: 23-25 liters at 15-18° C.; wash load size: 2.5 Kg; detergent dosage: 80 grams; water hardness: 100-150 ppm. The compositions of Table 1 were added during the rinsing step (110 mL) and a softness of the denim swatches was evaluated as follows: the denim swatches were dried in a tumble dryer at high temperature for 60 minutes. A softness of the denim swatches was evaluated by a panel individually asked to perform tactile assessments on a pair of denim swatches presented to them in a randomized sequence. The panelists were asked to touch, rub, and squeeze each denim swatch, and evaluate for softness, selecting the softer of the two denim swatches. The softer denim swatch was assigned a grade of 1 while the less soft denim swatch was assigned a grade of 2.

TABLE 1

| Ingredient | Comp. Ex. 1 | Example I |
|---|---|---|
| Water | q.s. | q.s. |
| Colorant | 0.0030% | 0.0030% |
| Acids and Preservatives | 0.082% | 0.082% |
| PQ7 | — | 0.16% |
| Esterquat | 3.0% | — |
| Alcohol C9-C11 | — | 2.0% |
| Conventional Thickener | 0.28% | — |
| Thickener (Alkont) | — | 0.91% |
| Free fragrance | 0.2% | 0.2% |
| Encapsulated Fragrance | 0.07% | — |
| Average Softness | 67 | 61 |

Parity in softness performance for the compositions in Table 1 can be determined by a softness score between 54 and 80. As illustrated in Table 1, an exemplary composition of the present invention Example I) using PQ7 instead of esterquat had an equivalent softness performance. In addition, Example I unexpectedly had a clear appearance, which is a desirable aesthetic in fabric care compositions.

Table 2 illustrates a performance comparison of another esterquat-containing fabric softening composition (4.5% esterquat—Comp. Ex. 2) against an exemplary fabric care composition according to the present disclosure (Example II).

The compositions of Table 2 were tested under the same conditions as those of Table 1.

TABLE 2

| Ingredient | Comp. Ex. 2 | Example II |
|---|---|---|
| Water | q.s. | q.s. |
| Colorant | 0.0030% | 0.0030% |
| Acids and Preservatives | 0.082% | 0.082% |
| PQ7 | — | 0.20% |
| Esterquat | 4.5% | — |
| Alcohol C9-C11 | — | 2.0% |
| Conventional Thickener | 0.30% | — |
| Thickener (Alkont) | — | 1.52% |
| Free fragrance | 0.6% | 0.6% |
| Encapsulated Fragrance | 0.18% | — |
| Average Softness | 75 | 79 |

Parity in softness performance for the compositions in Table 2 can be determined by a softness score between 62 and 88. As illustrated in Table 2, Example II using PQ7 instead of esterquat had an equivalent softness performance. In addition, Example II also had an unexpectedly clear appearance, which is a desirable aesthetic for fabric care compositions.

Table 3 illustrates a performance comparison of another esterquat-containing fabric softening composition (8.4% esterquat—Comp. Ex. 3) against another exemplary fabric care composition according to the present disclosure (Example III).

The compositions of Table were tested under the same conditions as those of Table 1.

TABLE 3

| Ingredient | Comp. Ex. 3 | Example III |
|---|---|---|
| Water | q.s. | q.s. |
| Colorant | 0.0030% | 0.0030% |
| Acids and Preservatives | 0.082% | 0.082% |
| PQ7 | — | 0.24% |
| Esterquat | 8.4% | — |
| Alcohol C9-C11 | — | 3.0% |
| Conventional Thickener | 0.05% | — |
| Thickener (Alkont) | — | 1.83% |
| Free fragrance | 0.81% | 0.81% |
| Encapsulated Fragrance | 0.15% | — |
| Average Softness | 65 | 58 |

Parity in softness performance for the compositions of Table 3 can be determined by a softness score between 52 and 78. As illustrated in Table 3, Example III using PQ7 instead of esterquat had an equivalent softness performance. In addition, Example III had an unexpectedly clear appearance, which is a desirable aesthetic for fabric care compositions.

Table 4 illustrates a performance comparison of another esterquat-containing fabric softening composition (3% esterquat—Comp. Ex. 4) against another exemplary fabric care composition according to the present disclosure that includes an encapsulated fragrance (Example IV).

The compositions of Table 4 were tested under the same conditions as those of Table 1.

TABLE 4

| Ingredient | Comp. Ex. 4 | Example IV |
|---|---|---|
| Water | q.s. | q.s. |
| Colorant | 0.0030% | 0.0030% |
| Acids and Preservatives | 0.082% | 0.082% |
| PQ7 | — | 0.16% |
| Esterquat | 3.0% | — |
| Alcohol C9-C11 | — | 2.0% |
| Conventional Thickener | 0.28% | — |
| Thickener (polyacrylate-1 | — | 0.5% |
| crosspolymer) | | |
| Free fragrance | 0.2% | 0.2% |
| Encapsulated Fragrance | 0.07% | 0.07% |
| Average Softness | 63 | 67 |

Parity in softness performance for the compositions in Table 4 can be determined by a softness score between 54 and 79. As illustrated in Table 4, Example IV using PQ7 instead of esterquat had an equivalent softness performance. In addition, even though Example IV included encapsulated fragrance it had a clear appearance. This was truly unexpected.

Dispersion and residue tests performed on Example 2 also confirm that the fabric care compositions of the present disclosure have equivalent or superior performance to that of esterquat-containing compositions when replacing the esterquat content with PQ7.

As can be seen from the data above, fabric care composition can be created using PQ7 instead of esterquat while maintaining equivalent or superior performance characteristics. In addition, using the thickeners and co-solvents of the present disclosure also allow for the creation of clear or translucent fabric care compositions.

The present disclosure has been described with reference to exemplary embodiments. Although a few embodiments have been shown and described, it will be appreciated by those skilled in the art that changes may be made in these embodiments without departing from the principles and spirit of preceding detailed description. It is intended that the present disclosure be construed as including all such modifications and alterations insofar as they come within the scope of the appended claims or the equivalents thereof.

1. A fabric care composition, comprising:
a fabric softening agent in an amount from 0.01 weight % to 2.5 weight %, based on a total weight of the fabric care composition, wherein the fabric softening agent comprises polyquaternium-7;
a thickener in an amount from 0.5 weight % to 4.0 weight %, based on the total weight of the fabric care composition, wherein the thickener comprises at least one of a polyoxyethylene sorbitol tetra stearate thickener and an acrylate copolymer; and
a co-solvent in an amount from 0.1 weight % to 5.0 weight %, based on the total weight of the fabric care composition, wherein the co-solvent comprises alcohol ethoxylates.

2. The fabric care composition of claim 1, wherein the fabric care composition is clear or translucent.

3. The fabric care composition of claim 2, wherein the fabric care compositions has a turbidity value of 50 NTU or less.

4. The fabric care composition of claim 2, wherein the fabric care compositions has a turbidity value of 30 NTU or less.

5. The fabric care composition of claim 1, wherein the fabric care composition comprises no surfactants other that the co-solvent and wherein the fabric softening agent consists of polyquaternium-7.

6. The fabric care composition of claim 1, wherein the fabric care composition has a viscosity from 30 to 500 cP.

7. The fabric softening composition of claim 1, further comprising:
an aqueous carrier; and
a fragrance in an amount from 0.01 weight % to 0.5 weight %, based on a total weight of the fabric care composition.

8. The fabric softening composition of claim 1, comprising:
from 0.01 weight % to 0.40 weight % polyquaternium-7;
an aqueous carrier; and
from 1.0 weight % to 4.0 weight % co-solvent.

9. The fabric softening composition of claim 1, wherein the fragrance is an encapsulated fragrance.

10. The fabric softening composition of claim 1, wherein the thickener comprises a polyoxyethylene sorbitol tetra stearate.

11. The fabric softening composition of claim 1, wherein the thickener comprises an acrylate copolymer.

12. The fabric softening composition of claim 1, wherein the co-solvent is an alcohol C9-C11 ethoxylate (EO 7.5:81).

13. A fabric care composition, comprising:
from 0.01 weight % to 0.40 weight % polyquaternium-7, based on a total weight of the fabric care composition;
an aqueous carrier;
from 0.5 weight % to 4.0 weight % thickener, based on the total weight of the fabric care composition;
from 0.1 weight % to 5.0 weight % co-solvent, based on the total weight of the fabric care composition; and
from 0.01 weight % to ×0.5% fragrance, based on the total weight of the fabric care composition,
wherein the fabric care composition comprises no other fabric softening agents or surfactants.

14. The fabric care composition of claim 13, wherein the fabric care composition has a clear or translucent appearance.

15. The fabric care composition of claim 14, wherein the fabric care composition has a turbidity value of 50 NTU or less.

16. The fabric care composition of claim 13, wherein the fabric care composition has a viscosity from 30 to 500 cP.

17. The fabric care composition of claim 13, wherein the components of the fabric care composition have a particle size of 50 nanometers or less.

18. The fabric care composition of claim 13, wherein the fragrance is an encapsulated fragrance and is provided as a micro-emulsion of the encapsulated fragrance and at least one of the thickener and the co-solvent.

19. The fabric care composition of claim 13, wherein the thickener comprises an acrylate copolymer or a polyoxyethylene sorbitol tetra stearate.

20. The fabric softening composition of claim 13, wherein the co-solvent is an alcohol C9-C11 ethoxylate (EO 7.5:81).
